(19) United States
(12) Patent Application Publication
(10) Pub. No.: US 2024/0194395 A1
(43) Pub. Date: Jun. 13, 2024

(54) MULTILAYER COIL ARRAY

(71) Applicant: Murata Manufacturing Co., Ltd., Kyoto-fu (JP)

(72) Inventors: Yoshiko BANNO, Nagaokakyo-shi (JP); Takashi TOMOHIRO, Nagaokakyo-shi (JP); Yuichi OHBA, Nagaokakyo-shi (JP)

(73) Assignee: Murata Manufacturing Co., Ltd., Kyoto-fu (JP)

(21) Appl. No.: 18/479,292

(22) Filed: Oct. 2, 2023

(30) Foreign Application Priority Data
Dec. 12, 2022 (JP) 2022-198006

(51) Int. Cl. H01F 27/29; H01F 17/00

(52) U.S. Cl. CPC H01F 27/292; H01F 17/0013

(57) ABSTRACT

A multilayer coil array includes an element body including a magnetic layer; a first coil inside the element body and including first coil conductor layers in a stacking direction; a second coil inside the element body at a position further from a bottom surface of the element body than the first coil in the stacking direction and including second coil conductor layers in the stacking direction; first and second outer electrodes on the bottom surface of the element body and electrically connected to the first coil; third and fourth outer electrodes on the bottom surface of the element body and electrically connected to the second coil; and a first lead-out conductor inside the element body and connecting, out of end portions of the first coil, an end portion of the first coil conductor layer closest to the second coil to the first outer electrode.

### CROSS-REFERENCE TO RELATED APPLICATION

This application claims benefit of priority to Japanese Patent Application No. 2022-198006, filed Dec. 12, 2022, the entire content of which is incorporated herein by reference.

### BACKGROUND

### Technical Field

The present disclosure relates to a multilayer coil array.

### Background Art

Japanese Unexamined Patent Application Publication No. 2020-61415 discloses a multilayer coil array for use in a DC-DC converter. The multilayer coil array includes an element body including magnetic layers containing magnetic particles, a first coil and a second coil built into the element body, and a first outer electrode, a second outer electrode, a third outer electrode, and a fourth outer electrode provided on a surface of the element body and each electrically connected to a corresponding one of the end portions of the first coil and second coil. A non-magnetic layer is provided between the first coil and the second coil. The first coil and the second coil each consist of a plurality of coil conductors connected to each other in a stacking direction. Among the plurality of coil conductors of the first coil, an end portion led out from the coil conductor closest to the second coil is connected to the first outer electrode, and the other end portion of the first coil is connected to the second outer electrode. Among the plurality of coil conductors of the second coil, an end portion led out from the coil conductor closest to the first coil is connected to the third outer electrode, and the other end portion of the second coil is connected to the fourth outer electrode. The first outer electrode and the third outer electrode are connected to output terminals of a switching element of the DC-DC converter.

As illustrated in FIG. 1B of Japanese Unexamined Patent Application Publication No. 2020-61415, the end portions of the first coil or the second coil are provided with lead-out conductors for connection to outer electrodes, the lead-out conductors being disposed in the stacking direction (height direction T in FIG. 1B). To avoid these lead-out conductors, coil conductors constituting the first or second coil need to be disposed inward or outward from the lead-out conductors in plan view in the stacking direction.

However, as illustrated in FIG. 1B of Japanese Unexamined Patent Application Publication No. 2020-61415, there is a problem in that when the coil conductors constituting the first or second coil are disposed inward from the lead-out conductors, the inner diameter area of the coil conductors is reduced due to the coil conductors being located in areas where the lead-out conductors are avoided (hereinafter also referred to as “avoidance portions”), and consequently the inductance value is decreased. If the width of the coil conductors is decreased in order to secure the inner diameter area of the coil conductor, there is a problem in that the DC resistance (Rdc) is increased.

On the other hand, although not described in Japanese Unexamined Patent Application Publication No. 2020-61415, if the coil conductors constituting the first or second coil are disposed outward from the lead-out conductor, there is a problem in that the inductance value tends to decrease because the area of the actual magnetic path is reduced by an amount corresponding to the thicknesses of the lead-out conductors.

Note that the above problems are not restricted to multilayer coil arrays for DC-DC converters and are common to multilayer coil arrays.

### SUMMARY

Accordingly, the present disclosure provides a multilayer coil array in which a reduction in the inductance value can be suppressed while suppressing an increase in the DC resistance value.

A multilayer coil array of the present disclosure includes an element body including a magnetic layer; a first coil provided inside the element body and including a plurality of first coil conductor layers in a stacking direction; and a second coil provided inside the element body at a position further from a bottom surface of the element body than the first coil in the stacking direction and including a plurality of second coil conductor layers in the stacking direction. The multilayer coil array also includes a first outer electrode and a second outer electrode provided on the bottom surface of the element body and electrically connected to the first coil; and a third outer electrode and a fourth outer electrode provided on the bottom surface of the element body and electrically connected to the second coil. In addition, the multilayer coil array further includes a first lead-out conductor provided inside the element body and connecting, out of end portions of the first coil, an end portion of the first coil conductor layer closest to the second coil and the first outer electrode to each other; a second lead-out conductor provided inside the element body and connecting another end portion of the first coil and the second outer electrode to each other; a third lead-out conductor provided inside the element body and connecting, out of end portions of the second coil, an end portion of the second coil conductor layer closest to the first coil and the third outer electrode to each other; and a fourth lead-out conductor provided inside the element body and connecting another end portion of the second coil and the fourth outer electrode to each other. The first coil conductor layers include an avoidance portion and a straight portion connected to the avoidance portion, the avoidance portion disposed inward or outward from the first lead-out conductor in plan view in the stacking direction so as to avoid at least the first lead-out conductor. The second coil conductor layers include an avoidance portion and a straight portion connected to the avoidance portion, the avoidance portion being disposed inward or outward from the fourth lead-out conductor in plan view in the stacking direction so as to avoid the fourth lead-out conductor. A width of the first coil conductor layer in the avoidance portion in at least one location is smaller than a width of the first coil conductor layer in the straight portion, a width of the second coil conductor layer in the avoidance portion is smaller than a width of the second coil conductor layer in the straight portion, or a width of the first coil conductor layer in the avoidance portion in at least one location is smaller than a width of the first coil conductor layer in the straight portion and a width of the second coil conductor layer in the avoidance portion is smaller than a width of the second coil conductor layer in the straight portion.

According to the present disclosure, a multilayer coil array can be provided in which a reduction in inductance value can be suppressed while suppressing an increase in DC resistance.

### BRIEF DESCRIPTION OF THE DRAWINGS

FIG. 1 is a perspective view schematically illustrating an example of a multilayer coil array according to the present disclosure;

FIG. 2 is a perspective view schematically illustrating an example of the internal structure of the multilayer coil array illustrated in FIG. 1;

FIG. 3 is a perspective view in which a first coil, a first lead-out conductor, and a second lead-out conductor have been extracted from the internal structure illustrated in FIG. 2;

FIG. 4 is a perspective view in which a second coil, a third lead-out conductor, and a fourth lead-out conductor have been extracted from the internal structure illustrated in FIG. 2;

FIG. 5 is a plan view in which the internal structure illustrated in FIG. 2 is viewed from a bottom surface side of an element body;

FIG. 6 is a plan view for explaining a method for measuring the width of a first coil conductor layer in an avoidance portion when the first coil conductor layer is curved;

FIG. 7A is a graph illustrating the relationship between the rate of increase of the average DC resistance (horizontal axis) and the rate of increase of the average inductance value (vertical axis) when A=B=0.190 is used as a reference, where A is the width of a first coil conductor layer or a second coil conductor layer in an avoidance portion and B is the width of the first coil conductor layer or second coil conductor layer in a straight portion;

FIG. 7B is a graph illustrating the relationship between the rate of increase of the average DC resistance (horizontal axis) and the ratio of average inductance value to average DC resistance (vertical axis) when A=B=0.190 is used as a reference;

FIG. 8 is a plan view schematically illustrating a First Modification of the internal structure of the multilayer coil array of the present disclosure; and

FIG. 9 is a plan view schematically illustrating a Second Modification of the internal structure of the multilayer coil array of the present disclosure.

### DETAILED DESCRIPTION

Hereinafter, a multilayer coil array according to the present disclosure will be described. Note that the present disclosure is not limited to the following configurations and may be modified as appropriate within a range that does not depart from the gist of the present disclosure. Furthermore, combinations of a plurality of the preferred configurations described below are also included in the scope of the present disclosure.

A multilayer coil array of the present disclosure is, for example, for use in a DC-DC converter. A multilayer coil array of the present disclosure can also be applied to applications other than DC-DC converters.

In the present specification, terms expressing the relationship between components (for example, “parallel”, “perpendicular”, and so on) and the shapes of components do not express only a strict meaning, but rather are intended to include substantially equivalent ranges, for example, differences of several percent.

The drawings referred to below are schematic drawings, and dimensions, aspect ratios, and so in the drawings on may differ from those of an actual product.

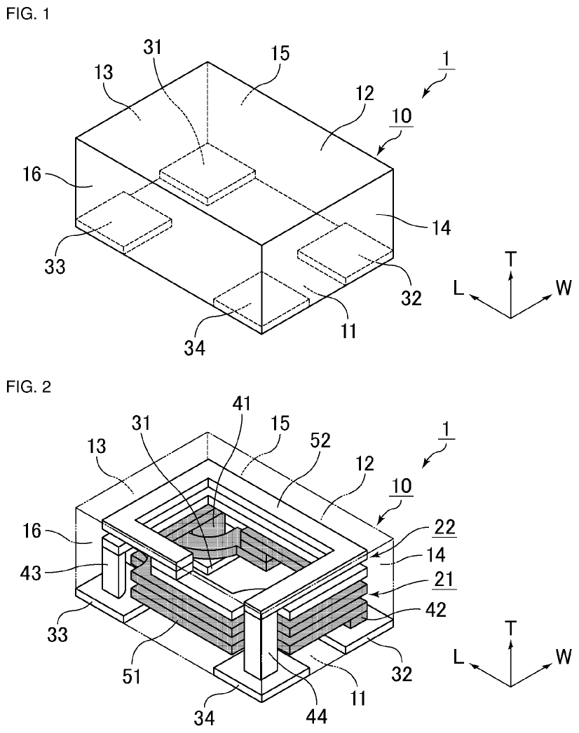

FIG. 1 is a perspective view schematically illustrating an example of a multilayer coil array of the present disclosure. FIG. 2 is a perspective view schematically illustrating an example of the internal structure of the multilayer coil array illustrated in FIG. 1. The shapes, arrangements, and so forth of the multilayer coil array and the individual components are not limited to those illustrated.

A multilayer coil array 1 illustrated in FIGS. 1 and 2 includes an element body 10, a first coil 21, a second coil 22, a first outer electrode 31, a second outer electrode 32, a third outer electrode 33, a fourth outer electrode 34, a first lead-out conductor 41, a second lead-out conductor 42, a third lead-out conductor 43, and a fourth lead-out conductor 44.

The element body 10 has, for example, a rectangular parallelepiped shape or a substantially rectangular parallelepiped shape having six surfaces. Corner portions and edge portions of the element body 10 may be rounded. The term “corner portion” refers to a part of the element body 10 where three surfaces intersect and the term “edge portion” refers to a part of the element body 10 where two surfaces intersect.

In FIGS. 1 and 2, a length direction, a width direction, and a height direction of the multilayer coil array 1 and the element body 10 are illustrated as an L direction, a W direction, and a T direction, respectively. The length direction L, the width direction W, and the height direction T are perpendicular to each other. A mounting surface of the multilayer coil array 1 is, for example, a surface that is parallel to the length direction L and the width direction W (LW surface).

The element body 10 illustrated in FIG. 1 has a first main surface 11 and a second main surface 12, which face each other in the height direction T, a first end surface 13 and a second end surface 14, which face each other in the length direction L perpendicular to the height direction T, and a first side surface 15 and a second side surface 16, which face each other in the width direction W perpendicular to the length direction L and the height direction T. In the example illustrated in FIG. 1, the first main surface 11 of the element body 10 corresponds to a bottom surface of the element body 10.

The element body 10 includes magnetic layers.

The element body 10 preferably has a multilayer structure. Specifically, the element body 10 preferably includes a plurality of magnetic layers in the stacking direction (for example, in the height direction T). The boundaries of each layer of the multilayer structure of the element body 10 do not need to be clearly visible.

When the element body 10 has a multilayer structure, there is a higher degree of freedom in the design of the multilayer coil array 1. For example, when manufacturing the multilayer coil array 1 that is provided with the first outer electrode 31, the second outer electrode 32, the third outer electrode 33, and the fourth outer electrode 34 on the bottom surface (first main surface 11) of the element body 10, it is easier to lead out the first coil 21 and second coil 22 to the bottom surface side.

The magnetic layers contain magnetic particles composed of a magnetic material. The magnetic particles may be particles composed of a metal magnetic material (metal magnetic particles) such as Fe, Co, Ni or an alloy including at least one of these metals, or may be ferrite particles. The magnetic particles are preferably Fe particles or Fe alloy particles. Preferred Fe alloys include Fe—Si alloys, Fe—Si—Cr alloys, Fe—Si—Al alloys, Fe—Si—B—P—Cu—C alloys, and Fe—Si—B—Nb—Cu alloys.

It is preferable that the surfaces of the metal magnetic particles composed of a metal magnetic material described above be covered with an insulating film. The degree of insulation between the metal magnetic particles can be increased when the surfaces of the metal magnetic particles are covered with an insulating film. A sol-gel method or a mechanochemical method can be used to form the insulating film on the surfaces of the metal magnetic particles. The material forming the insulating film is preferably an oxide of P, Si, or the like. Furthermore, the insulating film may be an oxide film formed by oxidizing the surfaces of the metal magnetic particles. The thickness of the insulating film is preferably from 1 to 50 nm, more preferably from 1 to 30 nm, and still more preferably from 1 to 20 nm. The thickness of the insulating film may be measured by capturing an image using a scanning electron microscope (SEM) of a cross section obtained by grinding down a multilayer coil array test piece and measuring the thickness of the insulating film on the surfaces of the metal magnetic particles from the obtained SEM image.

The average particle diameter of the metal magnetic particles in the magnetic layers is preferably from 1 to 30 μm, more preferably from 1 to 20 μm, and still more preferably from 1 to 10 μm. The average particle diameter of the metal magnetic particles in the magnetic layers can be measured using the procedure described below. Images of a cross section obtained by cutting a test piece of the multilayer coil array are captured at a plurality of (for example, five) regions (for example, 130 μm×100 μm) using an SEM, the obtained SEM images are analyzed using image analysis software (for example, A Zou Kun (Registered Trademark) produced by Asahi Kasei Engineering Corporation), and the equivalent circle diameters of the metal magnetic particles are obtained. The average value of the obtained equivalent circle diameters is obtained as the average value of the metal magnetic particles.

The element body 10 may include a non-magnetic layer between the first coil 21 and the second coil 22. The degree of insulation between the first coil 21 and the second coil 22 can be increased and the occurrence of short circuits between the first coil 21 and the second coil 22 can be suppressed by providing a non-magnetic layer between the first coil 21 and the second coil 22.

The non-magnetic layer may include a glass ceramic material, a non-magnetic ferrite material, and so on as a non-magnetic material. The non-magnetic layer preferably includes a non-magnetic ferrite material as a non-magnetic material. A nonmagnetic ferrite material having a composition that contains 40 to 49.5 mol % of Fe in the form of Fe₂O₃, 6 to 12 mol % of Cu in the form of CuO, with the remainder consisting of ZnO can be used as the non-magnetic ferrite material. The non-magnetic material may include Mn₃O₄, Co₃O₄, SnO₂, Bi₂O₃, SiO₂, and so on as necessary as additives and the non-magnetic material may also contain trace amounts of unavoidable impurities. The non-magnetic layer preferably contains a Zn—Cu ferrite.

The thickness of the non-magnetic layer can be measured using the procedure described below. A multilayer coil array test piece is stood up vertically, the region surrounding the test piece is filled with resin, and the resin is solidified. At this time, the LT surface is exposed. The grinding performed with a grinding machine is terminated at depth of around ½ the dimension of the test piece in the W direction of the test piece and a cross section parallel to the LT surface is exposed. After termination of the grinding, the ground surface is processed using ion milling (Ion Milling Apparatus IM4000 manufactured by Hitachi High-Technologies Corp.) in order to remove undercuts produced by the grinding from the inner conductors. An image of a portion substantially in the center of the non-magnetic layer in the ground test piece is captured using an SEM, the thickness of the portion substantially in the center of the non-magnetic layer is measured from the obtained SEM image, and this measured value is taken as the thickness of the non-magnetic layer.

The element body 10 may include non-magnetic portions between a plurality of first coil conductor layers 51 constituting the first coil 21 or between a plurality of second coil conductor layers 52 constituting the second coil 22. In this case, the non-magnetic portions are provided between adjacent coil conductor layers among at least either the first coil conductor layers 51 or the second coil conductor layers 52. Providing non-magnetic portions between adjacent coil conductor layers prevents leakage of magnetic flux.

It is preferable that the non-magnetic layer and the non-magnetic portions have the same composition. For example, it is preferable that the non-magnetic layer and the non-magnetic portions be formed of a Zn—Cu ferrite.

The first coil 21 and the second coil 22 are provided inside the element body 10. The first coil 21 and the second coil 22 are preferably magnetically coupled with each other. Two coils, including only the first coil 21 and the second coil 22, may be provided inside the element body 10 or three or more coils, including the first coil 21 and the second coil 22, may be provided inside the element body 10.

The first coil 21 includes a plurality of first coil conductor layers 51 in the stacking direction (for example, the height direction T). Adjacent first coil conductor layers 51 are connected to each other by via conductors. The first coil 21 may include two first coil conductor layers 51 in the stacking direction or may include three or more first coil conductor layers 51 in the stacking direction.

The first coil conductor layers 51 preferably all have the same thickness. In addition, the thickness of the first coil conductor layers 51 and the thickness of the second coil conductor layers 52, which are described later, are preferably substantially the same.

The second coil 22 is provided at a position that is further from the bottom surface of the element body 10 (first main surface 11) than the first coil 21.

The second coil 22 includes a plurality of second coil conductor layers 52 in the stacking direction (for example, the height direction T). Adjacent second coil conductor layers 52 are connected to each other by via conductors. The second coil 22 may include two second coil conductor layers 52 in the stacking direction or may include three or more second coil conductor layers 52 in the stacking direction. The number of stacked second coil conductor layers 52 may be the same as or different from the number of stacked first coil conductor layers 51.

The second coil conductor layers 52 preferably all have the same thickness.

The first outer electrode 31 and the second outer electrode 32 are provided on the bottom surface (first main surface 11) of the element body 10 and are electrically connected to the first coil 21. The third outer electrode 33 and the fourth outer electrode 34 are provided on the bottom surface (first main surface 11) of the element body 10 and are electrically connected to the second coil 22. The bottom surface of the element body 10 (first main surface 11) can be used as a mounting surface of the multilayer coil array 1. In other words, the multilayer coil array 1 can be mounted using the bottom surface of the multilayer coil array 1.

The first outer electrode 31 may be provided on only the first main surface 11 of the element body 10, or may be provided to extend over the first main surface 11 of the element body 10 and at least one out of the first end surface 13 and the first side surface 15 of the element body 10.

The second outer electrode 32 may be provided on only the first main surface 11 of the element body 10, or may be provided to extend over the first main surface 11 of the element body 10 and at least one out of the second end surface 14 and the first side surface 15 of the element body 10.

The third outer electrode 33 may be provided on only the first main surface 11 of the element body 10, or may be provided to extend over the first main surface 11 of the element body 10 and at least one out of the first end surface 13 and the second side surface 16 of the element body 10.

The fourth outer electrode 34 may be provided on only the first main surface 11 of the element body 10, or may be provided to extend over the first main surface 11 of the element body 10 and at least one out of the second end surface 14 and the second side surface 16 of the element body 10.

The first outer electrode 31, the second outer electrode 32, the third outer electrode 33, and the fourth outer electrode 34 may each be composed of a conductive material such as Ag. For example, the first outer electrode 31, the second outer electrode 32, the third outer electrode 33, and the fourth outer electrode 34 each include a base electrode layer containing Ag and one or more plating layers provided on the base electrode layer.

The thickness of each of the first outer electrode 31, the second outer electrode 32, the third outer electrode 33, and the fourth outer electrode 34 is preferably from 5 μm to 100 μm and more preferably from 10 μm to 50 μm.

The thickness of the outer electrodes, such as the first outer electrode 31, can be measured using the procedure described below. A test piece is ground down using the same method described above, and an image of an outer electrode part is captured using an SEM. A measurement is taken at one place substantially in the center of the outer electrode in the captured SEM image and the obtained value is taken to be thickness of the outer electrode.

The first lead-out conductor 41, the second lead-out conductor 42, the third lead-out conductor 43, and the fourth lead-out conductor 44 are provided inside the element body 10.

The first lead-out conductor 41 connects the end portion of the first coil conductor layer 51 closest to the second coil 22, which forms one of the end portions of the first coil 21, to the first outer electrode 31. The first lead-out conductor 41 preferably extends in the stacking direction (for example, height direction T). The first lead-out conductor 41 may have a multilayer structure.

The second lead-out conductor 42 connects the other end portion of the first coil 21 to the second outer electrode 32. The second lead-out conductor 42 preferably extends in the stacking direction (for example, height direction T). The second lead-out conductor 42 may have a multilayer structure.

The third lead-out conductor 43 connects the end portion of the second coil conductor layer 52 closest to the first coil 21, which forms one of the end portions of the second coil 22, to the third outer electrode 33. The third lead-out conductor 43 preferably extends in the stacking direction (for example, height direction T). The third lead-out conductor 43 may have a multilayer structure.

The fourth lead-out conductor 44 connects the other end portion of the second coil 22 to the fourth outer electrode 34. The fourth lead-out conductor 44 preferably extends in the stacking direction (for example, height direction T). The fourth lead-out conductor 44 may have a multilayer structure.

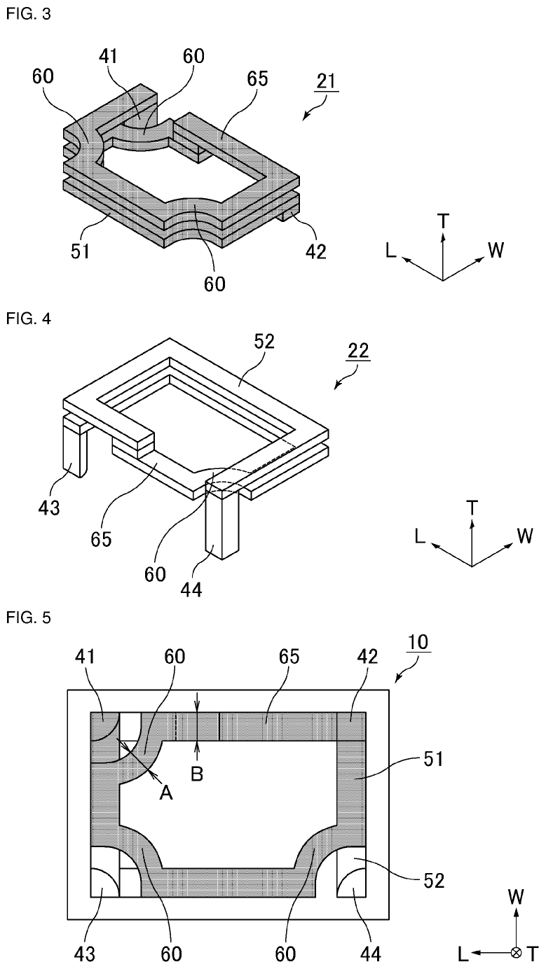

FIG. 3 is a perspective view in which the first coil, the first lead-out conductor, and the second lead-out conductor have been extracted from the internal structure illustrated in FIG. 2.

As illustrated in FIG. 3, each first coil conductor layer 51 includes avoidance portions 60 and straight portions 65 connected to the avoidance portions 60. The avoidance portions 60 are respectively disposed inward from the first lead-out conductor 41, the third lead-out conductor 43, and the fourth lead-out conductor 44 in plan view in the stacking direction (for example, in the height direction T) so that the first coil conductor layer 51 avoids the first lead-out conductor 41, the third lead-out conductor 43, and the fourth lead-out conductor 44.

It is sufficient that the avoidance portions 60 of the first coil conductor layers 51 be disposed inward from the first lead-out conductor 41 in plan view in the stacking direction (for example, height direction T) in order to avoid at least the first lead-out conductor 41. In other words, provided that the first coil conductor layers 51 include avoidance portions 60 for avoiding at least the first lead-out conductor 41, the first coil conductor layers 51 do not have to include avoidance portions 60 for avoiding at least one out of the third lead-out conductor 43 and the fourth lead-out conductor 44.

FIG. 4 is a perspective view in which the second coil, the third lead-out conductor, and the fourth lead-out conductor have been extracted from the internal structure illustrated in FIG. 2.

As illustrated in FIG. 4, the second coil conductor layers 52 include an avoidance portion 60 and straight portions 65 connected to the avoidance portion 60. The avoidance portion 60 is disposed inward from the fourth lead-out conductor 44 in plan view in the stacking direction (for example, height direction T) in order to avoid the fourth lead-out conductor 44.

In this specification, “avoidance portion 60” refers to the edge of the first coil conductor layer 51 or second coil conductor layer 52 that is closest to a lead-out conductor, such as the first lead-out conductor 41. The edge located in the avoidance portion 60 may be straight or curved. The avoidance portion 60 may be made up of two or more line segments.

FIG. 5 is a plan view in which the internal structure illustrated in FIG. 2 is viewed from the bottom surface side of the element body.

In the example illustrated in FIG. 5, the width of the first coil conductor layers 51 in the avoidance portions 60 (length denoted by A in FIG. 5) is smaller than the width of the first coil conductor layers 51 in the straight portions 65 (length denoted by B in FIG. 5).

By reducing the width of the first coil conductor layers 51 in the avoidance portions 60, rather than reducing the width of the entire first coil conductor layers 51, an increase in DC resistance can be suppressed. Furthermore, by reducing the width of the first coil conductor layers 51 in the avoidance portions 60, a reduction in the inner diameter area of the first coil conductor layers 51 can be suppressed, and therefore a reduction in the inductance value can be suppressed.

It is sufficient that the width of each first coil conductor layer 51 in the avoidance portion 60 in at least one location be smaller than the width of the first coil conductor layers 51 in the straight portions 65, but it is preferable that the width of each first coil conductor layer 51 in the avoidance portions 60 in all three locations be smaller than the width of the first coil conductor layers 51 in the straight portions 65.

Similarly, the width of the second coil conductor layer 52 in the avoidance portion 60 may be smaller than the width of the second coil conductor layers 52 in the straight portions 65.

In summary, the width of each first coil conductor layer 51 in the avoidance portion 60 in at least one location may be smaller than the width of the first coil conductor layers 51 in the straight portions 65, the width of the second coil conductor layer 52 in the avoidance portion 60 may be smaller than the width of the second coil conductor layers 52 in the straight portions 65, or the width of each first coil conductor layer 51 in the avoidance portion 60 in at least one location may be smaller than the width of the first coil conductor layers 51 in the straight portions 65 and the width of the second coil conductor layer 52 in the avoidance portion 60 may be smaller than the width of the second coil conductor layers 52 in the straight portions 65. Among these options, it is preferable that the width of each first coil conductor layer 51 in the avoidance portions 60 in all three locations be smaller than the width of the first coil conductor layers 51 in the straight portions 65, and that the width of the second coil conductor layer 52 in the avoidance portion 60 be smaller than the width of the second coil conductor layers 52 in the straight portions 65. Note that, in the first coil conductor layers 51, the width of the straight portions 65 does not have to be constant at each measurement position. In this case, the position where the straight portion 65 is narrowest is used as a measurement position. Similarly, in the second coil conductor layers 52, the width of the straight portions 65 does not have to be constant at each measurement position. In this case, the position where the straight portion 65 is narrowest is used as a measurement position.

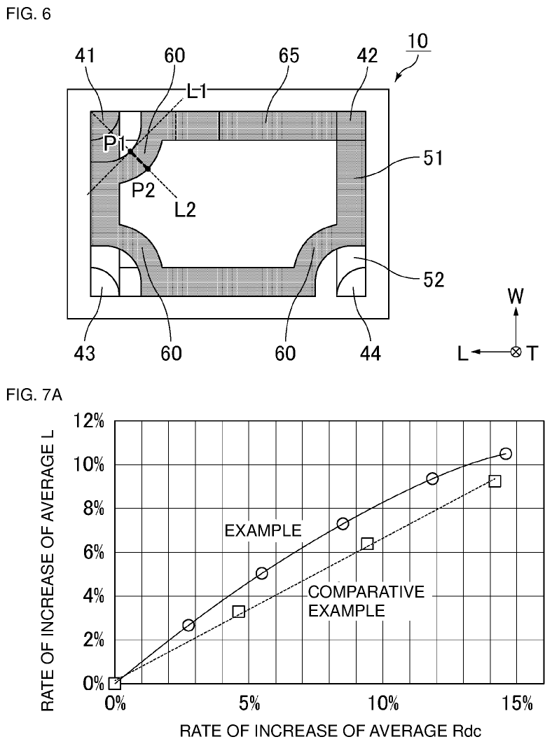

FIG. 6 is a plan view for explaining a method for measuring the width of the first coil conductor layer 51 in an avoidance portion 60 when the first coil conductor layer 51 is curved. If the first coil conductor layer 51 is straight in the avoidance portion 60 or if the avoidance portion 60 consists of two or more line segments, the position where the first coil conductor layer 51 in the avoidance portion 60 is narrowest is used as a measurement position.

A midpoint P1 of the outer circumference of the avoidance portion 60 of the first coil conductor layer 51 is found and a tangent line L1 at the outer circumference is drawn from the midpoint P1. A perpendicular line L2 that is perpendicular to the tangent line L1 is drawn from the midpoint P1. An intersection P2 between the inner circumference of the avoidance portion 60 of the first coil conductor layer 51 and the perpendicular line L2 is found. The width of the first coil conductor layer 51 in the avoidance portion 60 is defined as the length of the line segment connecting P1 to P2. The width of the second coil conductor layer 52 in the avoidance portion 60 can be measured using substantially the same method.

The multilayer coil array 1 illustrated in FIG. 1 can be manufactured, for example, using the method described in Japanese Unexamined Patent Application Publication No. 2020-61415, except that the widths of the first coil conductor layers 51 and the second coil conductor layers 52 will be changed. A plurality of multilayer coil arrays may be manufactured by molding a multilayer body corresponding to a plurality of multilayer coil arrays in an integrated fashion and then cutting the obtained body into individual chips.

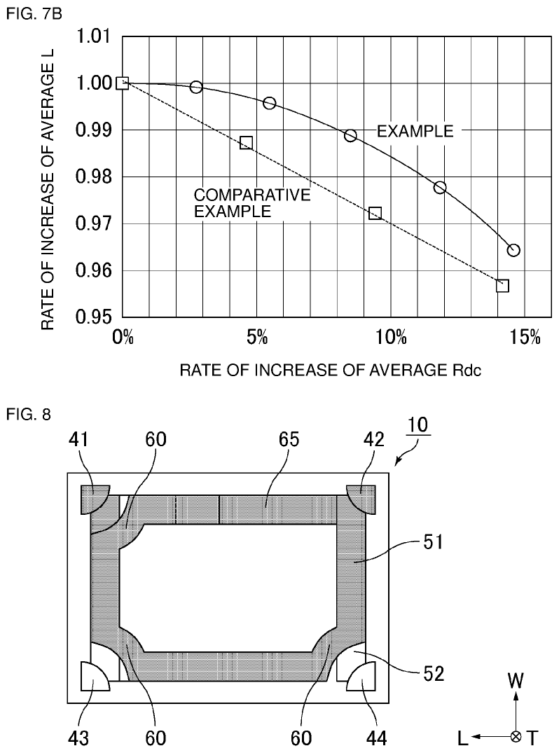

FIG. 7A is a graph illustrating the relationship between the rate of increase of the average DC resistance (horizontal axis) and the rate of increase of the average inductance value (vertical axis) when A=B=0.190 is used as a reference, where A is the width of a first coil conductor layer or a second coil conductor layer in an avoidance portion and B is the width of the first coil conductor layer or second coil conductor layer in a straight portion. FIG. 7B is a graph illustrating the relationship between the rate of increase of the average DC resistance (horizontal axis) and the ratio of average inductance value to average DC resistance (vertical axis) when A=B=0.190 is used as a reference.

FIGS. 7A and 7B illustrate simulation results for a multilayer coil array having the same internal structure as in FIG. 2. Specifically, simulation results are illustrated for when the values of A and B in all the avoidance portions 60 are varied to the values listed in Table 1 for all the layers. As illustrated in Table 1, in a comparative example, the width of the entire coil conductor layer is reduced, whereas in an example, the width of the coil conductor layer is reduced in the avoidance portions. FIG. 7A and FIG. 7B also illustrate a line that is a linear approximation of the results of the comparative example and a curve that is a quadratic approximation of the results of the example.

Note that the average DC resistance (average Rdc) is the average of the DC resistance of the first coil and the DC resistance of the second coil. The rate of increase of the average DC resistance (rate of increase of average Rdc) is the rate of increase relative to the average DC resistance (0%) at a reference A=B=0.190.

Similarly, the average inductance value (average of L) is the average of the inductance values of the first coil and the second coil. The rate of increase of the average inductance value (the rate of increase of average L) is the rate of increase relative to the average inductance value (0%) for a reference A=B=0.190.

TABLE 1

| | | COMPARATIVE | | | | | | | | |
|---|---|---|---|---|---|---|---|---|---|---|
| | | EXAMPLE | | | | EXAMPLE | | | | |
| COIL | VALUE OF A OF | 0.190 | 0.185 | 0.180 | 0.175 | 0.170 | 0.150 | 0.130 | 0.110 | 0.090 |
| | FIRST COIL | | | | | | | | | |
| | CONDUCTOR | | | | | | | | | |
| | LAYER (mm) | | | | | | | | | |
| | VALUE OF A OF | 0.190 | 0.185 | 0.180 | 0.175 | 0.170 | 0.150 | 0.130 | 0.110 | 0.090 |
| | SECOND COIL | | | | | | | | | |
| | CONDUCTOR | | | | | | | | | |
| | LAYER (mm) | | | | | | | | | |
| | VALUE OF B OF | 0.190 | 0.185 | 0.180 | 0.175 | 0.190 | 0.190 | 0.190 | 0.190 | 0.190 |
| | FIRST COIL | | | | | | | | | |
| | CONDUCTOR | | | | | | | | | |
| | LAYER (mm) | | | | | | | | | |
| | VALUE OF B OF | 0.190 | 0.185 | 0.180 | 0.175 | 0.190 | 0.190 | 0.190 | 0.190 | 0.190 |
| | SECOND COIL | | | | | | | | | |
| | CONDUCTOR | | | | | | | | | |
| | LAYER (mm) | | | | | | | | | |
| | RATIO OF A TO B | 1.000 | 1.000 | 1.000 | 1.000 | 0.895 | 0.789 | 0.684 | 0.579 | 0.474 |
| ANALYSIS | Rdc OF FIRST | 4.5 | 4.7 | 5.0 | 5.2 | 4.8 | 5.0 | 5.2 | 5.5 | 5.7 |
| RESULTS | COIL | | | | | | | | | |
| | Rdc OF SECOND | 6.2 | 6.5 | 6.7 | 7.0 | 6.2 | 6.3 | 6.4 | 6.4 | 6.5 |
| | COIL | | | | | | | | | |
| | AVERAGE Rdc | 5.4 | 5.6 | 5.9 | 6.1 | 5.5 | 5.6 | 5.8 | 6.0 | 6.1 |
| | RATE OF | 0% | 5% | 9% | 14% | 3% | 5% | 9% | 12% | 15% |
| | INCREASE OF | | | | | | | | | |
| | AVERAGE Rdc | | | | | | | | | |
| | L OF FIRST COIL | 31.1 | 32.4 | 33.6 | 34.8 | 32.6 | 33.9 | 35.1 | 36.3 | 36.8 |
| | L OF SECOND | 40.3 | 41.4 | 42.4 | 43.3 | 40.8 | 41.2 | 41.6 | 41.9 | 42.2 |
| | COIL | | | | | | | | | |
| | AVERAGE L | 35.7 | 36.9 | 38.0 | 39.0 | 36.7 | 37.5 | 38.4 | 39.1 | 39.5 |
| | RATE OF | 0.0% | 3.3% | 6.4% | 9.2% | 2.7% | 5.0% | 7.3% | 9.4% | 10.5% |
| | INCREASE OF | | | | | | | | | |
| | AVERAGE L | | | | | | | | | |
| | AVERAGE | 6.7 | 6.6 | 6.5 | 6.4 | 6.7 | 6.6 | 6.6 | 6.5 | 6.4 |
| | L/AVERAGE Rdc | | | | | | | | | |
| | RATIO OF | 1.00 | 0.99 | 0.97 | 0.96 | 1.00 | 1.00 | 10.99 | 0.98 | 10.96 |
| | AVERAGE L TO | | | | | | | | | |
| | AVERAGE Rdc | | | | | | | | | |

From FIGS. 7A and 7B and Table 1, it can be confirmed that by reducing the width of the first coil conductor layer 51 or the second coil conductor layer 52 in the avoidance portions 60 (i.e., making A/B<1), rather than reducing the width of the entire first coil conductor layer 51 or second coil conductor layer 52 (i.e., making A/B=1), a reduction in inductance value (L) can be suppressed while suppressing an increase in the DC resistance (Rdc). For example, the ratio of A to B is preferably greater than or equal to 0.474 and less than or equal to 0.895 (i.e., from 0.474 to 0.895), and more preferably greater than or equal to 0.579.

Multilayer coil arrays of the present disclosure are not limited to the above-described embodiment, and various applications and modifications can be made within the scope of the present disclosure with respect to the configuration of the multilayer coil array, manufacturing conditions, and so on.

FIG. 8 is a plan view schematically illustrating a First Modification of the internal structure of a multilayer coil array of the present disclosure.

In the example illustrated in FIG. 8, in plan view in the stacking direction (for example, height direction T), at least one lead-out conductor out of the first lead-out conductor 41, the second lead-out conductor 42, the third lead-out conductor 43, and the fourth lead-out conductor 44 is positioned further toward the outer edge of the element body 10 than the straight portions 65 of the first coil conductor layers 51 and the straight portions 65 of the second coil conductor layers 52.

A reduction in the inner diameter area of the first and second coil conductor layers 51 and 52 is further suppressed by disposing the lead-out conductors such as the first lead-out conductor 41 further towards the outer edge of the element body 10 than the straight portions 65, and therefore a reduction in the inductance value can be further suppressed.

As illustrated in FIG. 8, in plan view in the stacking direction (for example, height direction T), preferably, the first lead-out conductor 41, the second lead-out conductor 42, the third lead-out conductor 43, and the fourth lead-out conductor 44 are all positioned further towards the outer edge of the element body 10 than the straight portions 65 of the first coil conductor layers 51 and the straight portions 65 of the second coil conductor layers 52.

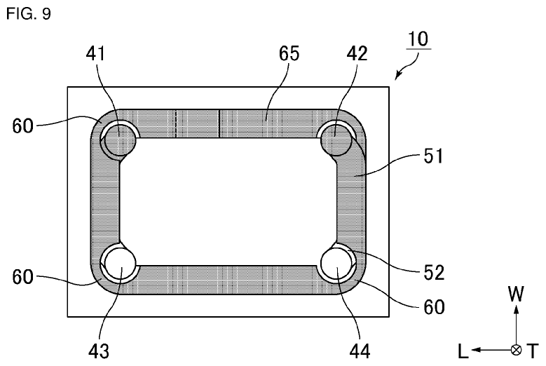

FIG. 9 is a plan view schematically illustrating a Second Modification of the internal structure of a multilayer coil array of the present disclosure.

In the example illustrated in FIG. 9, the avoidance portions 60 of the first coil conductor layers 51 are disposed outward from the first lead-out conductor 41 in plan view in the stacking direction so as to avoid at least the first lead-out conductor 41, and the avoidance portion 60 of the second coil conductor layer 52 is disposed outward from the fourth lead-out conductor 44 in plan view in the stacking direction so as to avoid the fourth lead-out conductor 44.

By disposing the avoidance portions 60 of the first coil conductor layers 51 or the second coil conductor layers 52 outward from lead-out conductors such as the first lead-out conductor 41, the inner-diameter areas of the first coil conductor layers 51 and the second coil conductor layers 52 can be secured. Furthermore, a reduction in the area of the element body 10 outside the first coil 21 and the second coil 22 is suppressed by reducing the width of the first coil conductor layers 51 or the second coil conductor layers 52 in the avoidance portions 60, and therefore a reduction in the inductance value can be suppressed.

As illustrated in FIG. 9, the avoidance portions 60 of the first coil conductor layers 51 may be disposed outward from each of the first lead-out conductor 41, the third lead-out conductor 43, and the fourth lead-out conductor 44 in plan view in the stacking direction so as to avoid the first lead-out conductor 41, the third lead-out conductor 43, and the fourth lead-out conductor 44. In this case, it is preferable that the width of the first coil conductor layers 51 in the avoidance portions 60 in all three locations be smaller than the width of the first coil conductor layers 51 in the straight portions 65, and that the width of the second coil conductor layer 52 in the avoidance portion 60 be smaller than the width of the second coil conductor layers 52 in the straight portions 65.

The following content is disclosed in the present specification.

<1> A multilayer coil array comprising an element body including a magnetic layer; a first coil provided inside the element body and including a plurality of first coil conductor layers in a stacking direction; a second coil provided inside the element body at a position further from a bottom surface of the element body than the first coil in the stacking direction and including a plurality of second coil conductor layers in the stacking direction; a first outer electrode and a second outer electrode provided on the bottom surface of the element body and electrically connected to the first coil; and a third outer electrode and a fourth outer electrode provided on the bottom surface of the element body and electrically connected to the second coil. The multilayer coil array also includes a first lead-out conductor provided inside the element body and connecting, out of end portions of the first coil, an end portion of the first coil conductor layer closest to the second coil and the first outer electrode to each other; a second lead-out conductor provided inside the element body and connecting another end portion of the first coil and the second outer electrode to each other; a third lead-out conductor provided inside the element body and connecting, out of end portions of the second coil, an end portion of the second coil conductor layer closest to the first coil and the third outer electrode to each other; and a fourth lead-out conductor provided inside the element body and connecting another end portion of the second coil and the fourth outer electrode to each other. the first coil conductor layers include an avoidance portion and a straight portion connected to the avoidance portion, the avoidance portion being disposed inward or outward from the first lead-out conductor in plan view in the stacking direction so as to avoid at least the first lead-out conductor. The second coil conductor layers include an avoidance portion and a straight portion connected to the avoidance portion, the avoidance portion being disposed inward or outward from the fourth lead-out conductor in plan view in the stacking direction so as to avoid the fourth lead-out conductor. A width of the first coil conductor layer in the avoidance portion in at least one location is smaller than a width of the first coil conductor layer in the straight portion, a width of the second coil conductor layer in the avoidance portion is smaller than a width of the second coil conductor layer in the straight portion, or a width of the first coil conductor layer in the avoidance portion in at least one location is smaller than a width of the first coil conductor layer in the straight portion and a width of the second coil conductor layer in the avoidance portion is smaller than a width of the second coil conductor layer in the straight portion.

<2> The multilayer coil array according to <1>, wherein the avoidance portion of the first coil conductor layer is disposed inward from the first lead-out conductor in plan view in the stacking direction so as to avoid at least the first lead-out conductor. Also, the avoidance portion of the second coil conductor layer is disposed inward from the fourth lead-out conductor in plan view in the stacking direction so as to avoid the fourth lead-out conductor.

<3> The multilayer coil array according to <2>, wherein the first coil conductor layers include a plurality of the avoidance portions and the avoidance portions are respectively disposed inward from the first lead-out conductor, the third lead-out conductor, and the fourth lead-out conductor in plan view in the stacking direction so as to avoid the first lead-out conductor, the third lead-out conductor, and the fourth lead-out conductor. Also, the width of the first coil conductor layer in the avoidance portions in all three locations is smaller than the width of the first coil conductor layer in the straight portion, and the width of the second coil conductor layer in the avoidance portion is smaller than the width of the second coil conductor layer in the straight portion.

<4> The multilayer coil array according to <2> or <3>, wherein in plan view in the stacking direction, at least one lead-out conductor out of the first lead-out conductor, the second lead-out conductor, the third lead-out conductor, and the fourth lead-out conductor is disposed nearer an outer edge of the element body than the straight portion of the first coil conductor layer and the straight portion of the second coil conductor layer.

<5> The multilayer coil array according to <1>, wherein the avoidance portion of the first coil conductor layer is disposed outward from the first lead-out conductor in plan view in the stacking direction so as to avoid at least the first lead-out conductor, and the avoidance portion of the second coil conductor layer is disposed outward from the fourth lead-out conductor in plan view in the stacking direction so as to avoid the fourth lead-out conductor.

<6> The multilayer coil array according to <5>, wherein the first coil conductor layers include a plurality of the avoidance portions and the avoidance portions are respectively disposed outward from the first lead-out conductor, the third lead-out conductor, and the fourth lead-out conductor in plan view in the stacking direction so as to avoid the first lead-out conductor, the third lead-out conductor, and the fourth lead-out conductor. Also, the width of the first coil conductor layer in the avoidance portions in all three locations is smaller than the width of the first coil conductor layer in the straight portion, and the width of the second coil conductor layer in the avoidance portion is smaller than the width of the second coil conductor layer in the straight portion.

<7> The multilayer coil array according to any one of <1> to <6>, wherein a ratio of A to B is greater than or equal to 0.474 and less than or equal to 0.895 (i.e., from 0.474 to 0.895) in all the avoidance portions in all layers, where A is the width of the first coil conductor layer or the second coil conductor layer in the avoidance portion and B is the width of the first coil conductor layer or the second coil conductor layer in the straight portion.

<8> The multilayer coil array according to <7>, wherein the ratio of A to B is greater than or equal to 0.579.

<9> The multilayer coil array according to any one of <1> to <8>, wherein the multilayer coil array can be used in a DC-DC converter.

What is claimed is:

1. A multilayer coil array comprising:
an element body including a magnetic layer;
a first coil inside the element body and including a plurality of first coil conductor layers in a stacking direction;
a second coil inside the element body at a position further from a bottom surface of the element body than the first coil in the stacking direction and including a plurality of second coil conductor layers in the stacking direction;
a first outer electrode and a second outer electrode on the bottom surface of the element body and electrically connected to the first coil;
a third outer electrode and a fourth outer electrode on the bottom surface of the element body and electrically connected to the second coil;
a first lead-out conductor inside the element body and connecting, out of end portions of the first coil, an end portion of the first coil conductor layer closest to the second coil and the first outer electrode to each other;
a second lead-out conductor inside the element body and connecting another end portion of the first coil and the second outer electrode to each other;
a third lead-out conductor inside the element body and connecting, out of end portions of the second coil, an end portion of the second coil conductor layer closest to the first coil and the third outer electrode to each other; and
a fourth lead-out conductor inside the element body and connecting another end portion of the second coil and the fourth outer electrode to each other,
wherein the first coil conductor layers include an avoidance portion and a straight portion connected to the avoidance portion, the avoidance portion being inward or outward from the first lead-out conductor in plan view in the stacking direction so as to avoid at least the first lead-out conductor,
the second coil conductor layers include an avoidance portion and a straight portion connected to the avoidance portion, the avoidance portion being inward or outward from the fourth lead-out conductor in plan view in the stacking direction so as to avoid the fourth lead-out conductor, and
a width of the first coil conductor layer in the avoidance portion in at least one location is smaller than a width of the first coil conductor layer in the straight portion, a width of the second coil conductor layer in the avoidance portion is smaller than a width of the second coil conductor layer in the straight portion, or a width of the first coil conductor layer in the avoidance portion in at least one location is smaller than a width of the first coil conductor layer in the straight portion and a width of the second coil conductor layer in the avoidance portion is smaller than a width of the second coil conductor layer in the straight portion.

2. The multilayer coil array according to claim 1, wherein
the avoidance portion of the first coil conductor layer is inward from the first lead-out conductor in plan view in the stacking direction so as to avoid at least the first lead-out conductor, and
the avoidance portion of the second coil conductor layer is inward from the fourth lead-out conductor in plan view in the stacking direction so as to avoid the fourth lead-out conductor.

3. The multilayer coil array according to claim 2, wherein
the first coil conductor layers include a plurality of the avoidance portions, and the avoidance portions are respectively positioned inward from the first lead-out conductor, the third lead-out conductor, and the fourth lead-out conductor in plan view in the stacking direction so as to avoid the first lead-out conductor, the third lead-out conductor, and the fourth lead-out conductor, and
the width of the first coil conductor layer in the avoidance portions in all three locations is smaller than the width of the first coil conductor layer in the straight portion, and the width of the second coil conductor layer in the avoidance portion is smaller than the width of the second coil conductor layer in the straight portion.

4. The multilayer coil array according to claim 2, wherein
in plan view in the stacking direction, at least one lead-out conductor out of the first lead-out conductor, the second lead-out conductor, the third lead-out conductor, and the fourth lead-out conductor is nearer an outer edge of the element body than the straight portion of the first coil conductor layer and the straight portion of the second coil conductor layer.

5. The multilayer coil array according to claim 1, wherein
the avoidance portion of the first coil conductor layer is outward from the first lead-out conductor in plan view in the stacking direction so as to avoid at least the first lead-out conductor, and
the avoidance portion of the second coil conductor layer is outward from the fourth lead-out conductor in plan view in the stacking direction so as to avoid the fourth lead-out conductor.

6. The multilayer coil array according to claim 5, wherein
the first coil conductor layers include a plurality of the avoidance portions and the avoidance portions are respectively positioned outward from the first lead-out conductor, the third lead-out conductor, and the fourth lead-out conductor in plan view in the stacking direction so as to avoid the first lead-out conductor, the third lead-out conductor, and the fourth lead-out conductor, and
the width of the first coil conductor layer in the avoidance portions in all three locations is smaller than the width of the first coil conductor layer in the straight portion, and the width of the second coil conductor layer in the avoidance portion is smaller than the width of the second coil conductor layer in the straight portion.

7. The multilayer coil array according to claim 2, wherein
a ratio of A to B is from 0.474 to 0.895 in all the avoidance portions in all layers, where A is the width of the first coil conductor layer or the second coil conductor layer in the avoidance portion and B is the width of the first coil conductor layer or the second coil conductor layer in the straight portion.

8. The multilayer coil array according to claim 7, wherein
the ratio of A to B is greater than or equal to 0.579.

9. The multilayer coil array according to claim 1, wherein
the multilayer coil array is configurable in a DC-DC converter.

10. The multilayer coil array according to claim 3, wherein
a ratio of A to B is from 0.474 to 0.895 in all the avoidance portions in all layers, where A is the width of the first coil conductor layer or the second coil conductor layer in the avoidance portion and B is the width of the first coil conductor layer or the second coil conductor layer in the straight portion.

11. The multilayer coil array according to claim 4, wherein
a ratio of A to B is from 0.474 to 0.895 in all the avoidance portions in all layers, where A is the width of the first coil conductor layer or the second coil conductor layer in the avoidance portion and B is the width of the first coil conductor layer or the second coil conductor layer in the straight portion.

12. The multilayer coil array according to claim 5, wherein
a ratio of A to B is from 0.474 to 0.895 in all the avoidance portions in all layers, where A is the width of the first coil conductor layer or the second coil conductor layer in the avoidance portion and B is the width of the first coil conductor layer or the second coil conductor layer in the straight portion.

13. The multilayer coil array according to claim 6, wherein
a ratio of A to B is from 0.474 to 0.895 in all the avoidance portions in all layers, where A is the width of the first coil conductor layer or the second coil conductor layer in the avoidance portion and B is the width of the first coil conductor layer or the second coil conductor layer in the straight portion.

14. The multilayer coil array according to claim 2, wherein
the multilayer coil array is configurable in a DC-DC converter.

15. The multilayer coil array according to claim 5, wherein
the multilayer coil array is configurable in a DC-DC converter.
